(19) United States
(12) Patent Application Publication
(10) Pub. No.: US 2006/0074799 A1
(43) Pub. Date: Apr. 6, 2006

(54) Method and system for integrated payment processing

(75) Inventors: Kelton Averyt, Bay View, TX (US); Martin Henderson, South Padre Island, TX (US); Bob Schmid, Vienna, VA (US); Bob Bennett, Arlington, VA (US); Gregg Cannella, Arlington, VA (US); Deborah Bowler, Dale City, VA (US)

Correspondence Address: FOLEY AND LARDNER LLP;SUITE 500, 3000 K STREET NW, WASHINGTON, DC, 20007, US

(73) Assignee: NETWORK 1 FINANCIAL, INC.

(21) Appl. No.: 10/954,228

(22) Filed: Oct. 1, 2004

(51) Int. Cl. G06Q 40/00

(52) U.S. Cl. 705/40

(57) ABSTRACT

An integrated payment processing system and method includes an input unit that receives payment data from at least three different payment types. A processing unit processes the payment data to associate the payment data with one or more payers and one or more goods or services, and a user interface unit allows a user to configure the payment processing system and configure the processing unit to process the payment data received by the input unit.

### FIELD OF THE INVENTION

The present invention relates generally to the field of payment processing. More specifically, the present invention relates to an integrated payment processing system and material that receives and processes payment data from at least three different payment types.

### BACKGROUND OF THE INVENTION

Convention payment processing systems do not allow for processing of three or more different payment types. For example, U.S. Pat. No. 5,484,988 to Hills et al. discloses a point of sale system that is designed to read information from a consumer's check or credit card with a subsequent debiting of the consumer's account and crediting of a merchant's account for the goods or services provided. For processing checks, this system scans and stores the transaction information for subsequent bank reconciliation over the Automated Clearing House (ACH) network and eliminates the need for paper checks.

U.S. Pat. No. 5,175,682 to Higashiyama et al. discloses a system and method that prioritizes checks for transmission to banks for processing. Therefore, information read from checks is used to send some checks for real time processing while other checks are stored in batches for batch processing. In some embodiments, selection criteria may be provided for determining which checks are to be processed in real time and which checks are to be processed in a batch mode.

U.S. Pat. No. 5,801,366 to Funk et al. describes an automated check processing system at a point of sale that receives checking amount information and a check amount information and stores the information in a transaction database. A power encoder then verifies the check data with the information in the transaction database before automatically encoding the check to ensure that the check is accurately encoded.

However, none of the current systems provide an integrated payment processing system suitable for use, for example, in a back office processing location that processes more than two types of payments and is configurable for providing functionality that is particularly advantageous in back office processing applications.

### SUMMARY OF THE INVENTION

One exemplary embodiment of the invention relates to an integrated payment processing system that includes an input unit that receives payment data from at least three different payment types, a processing unit that processes the payment data to associate the payment data with one or more payers and one or more goods or services, and a user interface unit that allows a user to configure the payment processing system and configure the processing unit to process the payment data received by the input unit.

In certain embodiments the integrated payment processing system also includes an integrated scanner that scans both a check and a credit card to generate the payment data.

In certain embodiments, the integrated payment processing system includes a customer database that stores information related to the payers and the goods or services that are paid for using the payment processing system.

In one embodiment, the present invention provides a computer implemented method that includes the steps of: (1) receiving, at a payment processing computer, payment data from at least three different payment types; (2) processing the payment data to associate the payment data with one or more payers and one or more goods or services; and (3) allowing a user to configure the payment processing computer to process the payment data received by the input unit.

In another embodiment, the present invention provides a computer program product including a computer readable medium having program code recorded thereon that, when executed, causes a computing system to perform payment processing, program code including code for receiving, at a payment processing computer, payment data from at least three different payment types; code for processing the payment data to associate the payment data with one or more payers and one or more goods or services; and code for allowing a user to configure the payment processing computer to process the payment data received by the input unit.

### BRIEF DESCRIPTION OF THE DRAWINGS

The accompanying drawings, which are incorporated in and constitute a part of the specification, illustrate embodiment(s) of the invention, and, together with the general description given above and the detailed description of the embodiment(s) given below, serve to explain the principles of the invention.

FIG. 1 is a system diagram that illustrates one embodiment of the payment processing system.

FIG. 2 is a desktop view of one embodiment of the payment processing system.

FIG. 3 is a flow chart illustrating the payment processing step in one embodiment of the invention.

### DETAILED DESCRIPTION

According to an embodiment of the present invention an Internet-accessible payment processing application and system that allows clients to accept and process multiple forms of payment, including paper checks for conversion, credit cards, and electronic checks through a check clearing facility such as the Automated Clearing House (ACH) is provided. The payment processing system combines physical and virtual payment processing. The system provides flexibility so that user can process its payments on time by choosing the most efficient processing method for a particular circumstance.

In certain embodiments, an Optical Scanner/Reader is integrated with the payment processing system. The scanner allows a user to convert paper consumer checks into acceptable ACH electronic payments. The reader processes “card present” credit card transactions.

In certain embodiments, the payment processing system can also be used to process recurring “virtual check” transactions and “card not present” credit card transactions. In order to process these types of transactions, typically it is necessary to have written authorization from the customer so that a recurring transaction can be set up for that customer.

The payment processing system provided by the present invention can be used by businesses that receive a lot of customer payments by check. With the payment processing system, a user can quickly and easily convert paper checks into electronic payments—revolutionizing the lockbox or check deposit process. Such a payment processing system may be very effective for the property management field and other markets where back office processing of checks is an important part of the business. In certain embodiments, the payment processing system includes customer management and import/export features and functions so that customer information and data from other systems can be seamlessly integrated into the payment processing system.

Certain embodiments of the payment processing system may provide one or more of the following benefits.

(1) Saves the user time and money.

(2) Provides one consistent, easy-to-learn/easy-to-use system which may be fully supported with training and help desks.

(3) Consolidates non-cash payment processing into one complete system.

(4) Reduces labor costs associated with check pick up and handling.

(5) Ensures fewer lost and/or damaged checks.

(6) Reduces the amount of time required to process a check.

(7) Allows the user to enter customer information only once; the system “recognizes” scanned checks and automatically apply the payment to the correct account.

(8) May allow the user to re-present a check two or more times.

(9) Provides automatic recurring billing for both ACH (electronic checks) and credit cards.

(10) Ensures faster check deposits and funds availability and thereby provides for improved cash flow and control of funds.

(11) Provides better and more timely reports regarding the payment processing system.

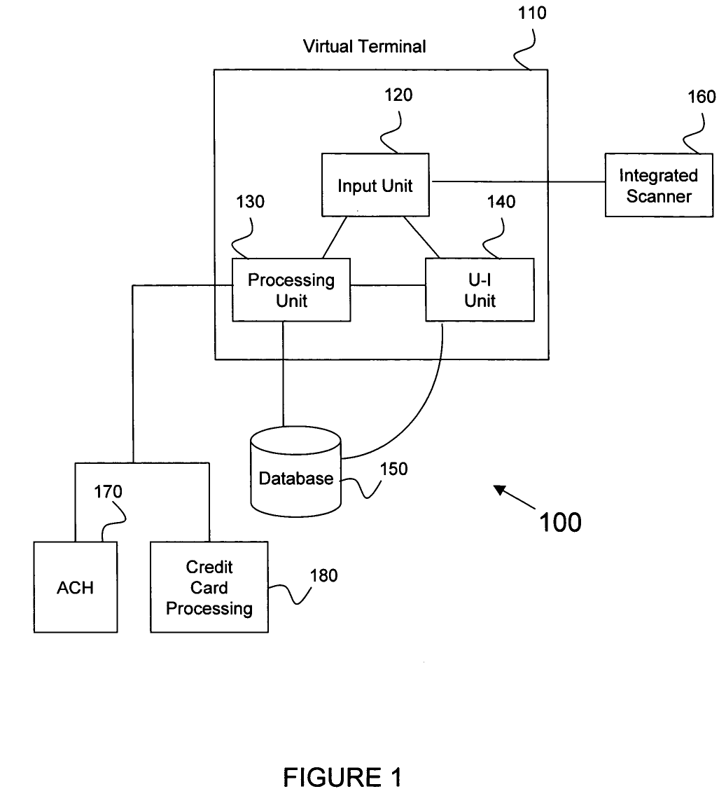

FIG. 1 is a system diagram that illustrates one embodiment of the payment processing system 100 provided by the present invention. It should be recognized that FIG. 1 is exemplary only and various modification and alternatives would be apparent to those skilled in the art. All of those modifications and alternatives are considered to be a part of the present invention.

The integrated payment processing system 100 includes a virtual terminal 110 that includes an input unit 120 which receives payment data from at least three different payment types. In one embodiment, the virtual terminal 110 is implement using a standard computing system such as a desktop personal computer.

As is well known to those skilled in the art such a computing system would include a processor (a CPU), memory (RAM and/or ROM), input devices (keyboard or mouse, for example), output devices (such as a printer), storage devices (disk drives or drives and/or slots for other fixed or removable media), communication ports/devices for connecting to other devices or networks using wired or wireless means. One skilled in the art would recognize that the above describes a typical computing system and its components suitable for connection to a network and would recognize various other configurations all of which are considered to be part of the present invention.

The virtual terminal 110 includes an input unit 120 which can receive input from a source of payment data. For example, in certain embodiments, the input unit 120 includes a serial or other communications port that connects to an integrated scanner 160 to receive data scanned in by the integrated scanner 160. The payment data received by the virtual terminal 110 can be stored and processed by a processing unit 130 based on processing logic provided by certain embodiments of the present invention.

The types of payment data that may be received by the input unit of the payment processing system includes: (1) physical credit card payments; (2) physical check payments for ACH transactions; (3) virtual recurring credit card payments (to be discussed later herein); (4) virtual recurring check/ACH payments (to be discussed further herein); and (5) check card transactions or signature debit card transactions.

The integrated scanner 160 is a device that can scan data from a credit card as well as data from a check. For example, the integrated scanner can read credit card data (for example, the credit card number and expiry date) for a credit card and then the amount of the transaction can be entered from a user interface unit 140. Alternatively, the processing unit 130 may receive the credit card data and query a database 150 to determine the other information that is required to complete a transaction.

One example of an integrated scanner is a MagTek MICR Image Optical Scanner/Reader provided by MagTek. Of course, it should be recognized that other scanners may be used instead as long as they provide similar functionality.

The virtual terminal 110 also includes the user interface unit 140 which allows a user to provide input to the payment processing system 100 and also customizes the payment processing system. The user interface unit 160 allows a user of the system to enter information to complete a transaction. For example, for a credit card scanned by the integrated scanner 140, the user interface unit 140 may be used to enter data that is required to complete the transaction (for example, the amount of the transaction). Likewise, for a check scanned by the integrated scanner 160, the user interface unit 140 may be used to enter additional data that is required to complete a transaction (for example, the amount of the transaction).

Furthermore, it should be noted that certain embodiments of the present invention use the integrated scanner 160 to scan credit cards and checks and other similar magnetic media. The present invention also contemplates reading data from other card technology including RFID, optical or other sensing means. However, it should be understood that the present invention would also work if different scanners were used for credit cards and checks as long as all of the scanner provided payment data is provided to the input unit 120 of the payment processing system.

In certain embodiments of the invention, a database 150 contains information about the various payers whose payments are to be processed by the payment processing system 100. This information regarding the payers may be entered using the user interface unit 140 or may be imported from another database or system using an import or conversion utility that would be understood by those skilled in the art.

Some of the information that may be stored at the database 150 may include: name and address of payers, payer's bank and account information, payer's credit card information, services or goods to be rented or purchased by payer, alternative payment mechanisms and priority of the alternative payment mechanisms, relationship of the payer with respect to payers who may jointly rent or purchase a good or service. One skilled in the art would recognize that the database 150 could be implemented, for example, by using relational or object oriented database technology. Designing the scheme and implementing the data structures to use such database technology is within the abilities of those skilled in the art.

For example, in certain embodiments, the database 150 may be a database of rental properties. Such a database would contain a list of all the renters for all the rental units in the property. In addition to the personal information of a renter, the database 150 contains the information regarding the rental payment and the credit card information or check payment information corresponding to that renter. In certain embodiments, the database 150 contains information regarding alternate methods of payment by a renter and an order may be specified between the alternate methods of payment by the renter. For example, the database may specify that a checking account is the method of payment that should be tried first for a renter when a payment is due. However, if that method of payment fails (for example, the bank does not pay because of insufficient funds), the database may specify that a credit card account may be charged. Other modes of payments may be tried if the credit card account is unable to provide the required payment.

In certain embodiments, a renter may be able to specify that multiple modes of payments be used to divide a single rental payment. For example, the renter may specify that 50% of each rental payment should be debited from the checking account while the remaining 50% is to be charged to a credit card account.

In addition, information regarding the rental (as one of example of a service) is also contained in the database 150. Such information includes, for example, the rental payment, its frequency, and the date of the month when the rental payment is due. In one aspect, the database 150 may also contain several payers for one rental unit even though one of the payers (or a subset of the payers) may be designated as the renter for contracting purposes. In this way, the rent for a single rental unit may be divided among the various renters, for example, on a percentage basis. Therefore, in certain embodiments of the payment processing system 100, the rent for a single rental unit may be allocated to multiple payers and this information is stored in the database 150. In this way, the payment processing system 100 is able to automatically generate transactions that collect a single rental payment from the multiple payers. For example, if a single rental payments is to be paid by two payers A and B with a ratio of 60% by A and 40% by B, the payment processing system generates one payment transaction of 60% that is collected from A (by either debiting A's bank account or charging A's credit card or both) and another payment transaction that is collected from B (by either debiting B's bank account or charging B's credit card or both).

Likewise, the database 150 is also used to store the information required for setting up recurring payments for a payer. Once authorization has been obtained by a user, the database 150 can store the payment source information (bank and account number, credit card information, etc.) as well as the amount and timing of the recurring payment so that a recurring payment indicator may be set up in the database. Thereafter, the payment processing system automatically sets up the payment transaction whenever a payment is due by generating a debit check transaction or a charge to the credit card (or both in some percentage). In this way, the recurring payments that are typical in many situations, such as in property rental, are managed efficiently by the payment processing system and provides benefits to both the party receiving and processing the recurring payment and also to the party making the payment since they do not need to separately initiate a payment each month.

The payment transactions that are generated, whether based on input from the integrated scanner or recurring transactions automatically generated based on data stored in the database, may be processed in a near real-time basis or may be processed in batches or a combination of two processing modes may be used. For example, payments above a certain amount may be sent for payment processing in real-time while smaller transactions may be grouped together for batch processing. Likewise, in certain embodiments, the payment processing system 100 may group together smaller transactions in a batch until their total reaches a certain threshold value before the batch is sent for processing or until a certain time period had elapsed (for example, at the end of a day).

Another feature provided by certain embodiments of the payments processing system 100 includes customized reports that are generated based on the information stored in the database 150. The payment processing system analyzes the payment patterns by a payer, rental unit, payment type for example and generates a report so that payment processing data can be conveniently analyzed. For example, if the report indicates that the check or ACH transactions for a particular payer are frequently rejected, the property manager may request the payer to provide additional modes of payment (for example, information and authorization to charge a credit card). The payment processing system (PPS) 100 can be set up to process a credit card payment upon a rejected ACH transaction. Conversely, the PPS 100 system can be set up to process an ACH transaction upon a rejected credit card transaction. In addition, reports regarding the batch and real-time payment can be conveniently generated to track the payment process.

In the event of a returned check, the payment processing system 100 can be set up so that the system can process incremental or partial payments that aggregate to a final total. For example, if a resident's check returns for a total of $500, the system can be programmed to process $100 transactions on a daily basis until the value of $500 is met. In the event of a rejected credit card transaction, the payment processing system 100 can be set up so that the system can process incremental or partial payments that aggregate to a final total. For example, if a resident's credit card transaction rejects for a total of $500, the system can be programmed to process $100 transactions on a daily basis until the value of $500 is met.

As would be recognized by those skilled in the art, the payment processing system 100 includes security features so that only authorized users could access particular data or initiate particular transactions. Some of the security features include one or more of user id/passwords, access control lists, encryption of some data so that the financial information in the database is secured and is not easily accessible to an authorized user.

In the following sections, an implementation of one embodiment of payment processing system (“PPS”) is discussed in more detail below. In this embodiment, the PPS is also interchangeably referred to as “Collect Direct” in some of the view discussed in the following sections.

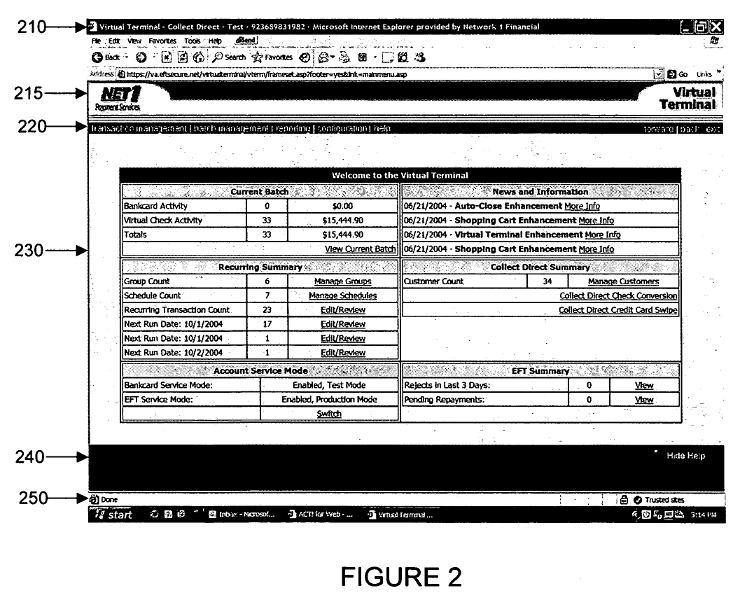

FIG. 2 discloses an exemplary view 200 of the PPS system as may be displayed on a computer monitor. FIG. 2 is merely an exemplary configuration, and the scope of the present invention includes other arrangements, displays and user interfaces that facilitate the user's interaction with the PPS system.

The PPS is a system (or application) that is accessed through a network connection such as an Internet connection. The PPS application page consists of a Title Bar 210, a system ID (Identification) Bar 215, a Menu Bar 220, the View Area 230, a Quick Tips Help Bar 240, and a Message/Status Bar 250. Within the application, this page is called the Desktop View 200 as shown in FIG. 2. The Desktop View 200 provides the initial user interface to the PPS functions.

The PPS Menu Bar 220 consists of five drop-down menus and three navigation menu commands. The Menu Bar Components topic lists and describes the menus and navigation commands. The Using the Menu Bar topic describes how to open the drop-down menus and how to start the menu commands. The components of the Menu Bar 270 include:
Transaction Management menu—Consists of the Transaction Review, Transaction Processing, and Customer Management menu commands.
Batch Management menu—Consists of the Current Batch Detail Report, Settle Current Batch, Settled Batches, and the Batch Uploads menu commands.
Reporting menu—Consists of the Transaction Reporting, Batch Reporting, Recurring Reporting, Other Reporting, and Import/Export Utilities menu commands.

Configuration menu—Consists of the Account Configuration, User Management, Email Notices, User Preferences, Advanced Options, Change Password, and Optical Scanner Configuration menu commands.
Help menu—Consists of the Desktop View, FAQ, Online Tutorials, Users Manual, Technical Support, Advanced Integration, ACH Reject Codes, Contact Risk Department, Feedback, Voice Authorization, and View Quick Tips menu commands.

The View Area 230 of the PPS is where the system displays the forms in the application that a user works with. Each of these forms is called a “View” because it is what the user is currently viewing within the area of the application window. In Windows terminology, it is the same as the Display Area of a window or dialog box. In Web terminology, it is the same as a pane.

The forms—or “Views”—are similar to paper forms a user might work with. The user can read (or review) a form, select options (similar to multiple choice or check boxes on a paper form), or type information in a text box (fill in the blank).

When you first access the PPS Web application, the Welcome to the Virtual Terminal View—also called the Desktop View 200—is open and active. This view is used to quickly review Current Batch activity, News and Information activity, Recurring Summary information, and PPS Summary information. Each of these frames is discussed next.

On the Welcome to Collect Direct Desktop View 200, the Current Batch frame shows the number of transactions and dollar amounts for current batch bankcard activity and virtual check activity. In addition, it shows the total transactions and total dollar amounts for both of these activities. Then, it provides a user with a command link to the Current Batch Report View.

Click on the View Current Batch command link to open the Current Batch Detail Report View. Use the Current Batch Report View to examine, void, adjust, or process transactions generated on this report.

On the Welcome to Collect Direct Desktop View 200, the News and Information frame shows the date of recently added features, the feature name, and a More Info command link. Click on the More Info command link to open the Collect Direct News message box. The message box provides a summary of the feature. To close the message box, click on the Close Window button. The message box closes; the Desktop View is still open and active.

On the Welcome to Collect Direct Desktop View 200, the Recurring Summary frame lists recurring transactions, provides the number of transactions for each transaction type, and provides a command link to the relevant View within PPS where you can review additional information about the transaction type.

On the Welcome to Collect Direct Desktop View 200, the PPS Summary frame tells a user his customer count. The Manage Customers command link opens the Customer Management View. The PPS Check Conversion command link opens the PPS Virtual Check Service View. The Collect Direct Credit Card Swipe command link opens the PPS Bankcard Service View.

Before working with the PPS system, a user should confirm their account information, set up and manage user access rights, configure the e-mail notifications, specify user preferences and advanced configuration options, change password, and configure the optical check scanner.

The description below provides a condensed version of some of the major features and functions contained within one exemplary embodiment of the PPS Web application. The PPS is a Web application that works in unison with an optical check scanner/bankcard reader.

In one embodiment of the PPS system, the user is initially provided with a Merchant ID, User Name, and Password. The exemplary embodiment of the PPS may include the following list of features.

Log In
Change Your Password
Verify Your Account Services
Configure and Test the Optical Scanner/Reader
Set Up Merchant E-Mail Notifications
Set Up Customers
Set Up Customers Payer Options
Work with the Desktop View
Scan a Check - Existing Customer
Scan a Check - New Customer
Swipe a Credit Card
Set Up Reports
Review Batch Transactions
Settle Batch Transactions
EFT Rejects
EFT Repayments

In one embodiment, the process for logging in may include the following steps:
1. In an Internet browser's Address box, type:
   https://va.eftsecure.net/virtualterminal
   The Merchant Login dialog box opens.
2. In the Merchant ID box, type the user's NET1 Merchant ID
3. In the Username box, type the user name
4. In the Password box, type the password.
5. Click on the Login button. OR: Press the Enter key. The PPS Web application window opens.

According to an exemplary embodiment, the steps for changing the password may include the following steps:
1. From the Menu Bar, select the Configuration menu> Change Password menu command. The Change User Password View opens.
2. In the New Password box, type your new password. Minimum 8 characters, maximum 16 characters, case-sensitive.
3. In the Confirm New Password box, retype your new password.
4. Click on the Update button.

According to an exemplary embodiment, to verify account services, a user may perform the following steps:
1. From the Menu Bar, select the Configuration menu> Account Configuration menu command. The Account Configuration View opens.
2. Verify that the services specified in the Service Agreement appear as “Enabled.”
3. Verify that the logos for the credit cards selected on the user's Bankcard Services application appear in the Bankcard Service pane.

Furthermore according to another exemplary embodiment, steps to configure and test the optical scanner/reader may include the following steps.
1. Connect the MagTek MICRImage Optical Scanner/Reader to a PC.
2. From the Menu Bar, select the Configuration menu> Optical Scanner menu command.
3. From the Security Warning dialog box, click on the Yes button.
4. In the PPS Configuration Manager frame, delete the default text “Your Organization.” Then, type the user's Corporate Name.
5. In the Local Image Path box, you can keep the default directory of C:\Temp\ or you can specify a different directory.
6. In the Communications Port box, select the number that represents the communications port on your PC to which you connected the MagTek MICRImage Optical Scanner/Reader.
7. Click on the Save Settings button.
8. From the message box, click on the OK button.
9. From the PPS Configuration Test frame, click on the Test button.

The PPS system may be configured so that only a User with Administrator privileges can add a new user and grant or restrict a user's access rights to the PPS system. For example, access rights may be changed utilizing the following steps:
1. From the Menu Bar, select the Configuration menu, User Management menu command. The User Management View opens.
2. Click on the Add User command link. The Add User View opens.
3. In the User Name box, type a User Name for the user you are adding. Minimum 8 characters; maximum 16 characters.
4. In the Password box, type a password for the new user. Minimum 8 characters; maximum 16 characters; case-sensitive.
5. In the Confirm Password box, type the password again.
6. To grant the new user access to features, select “Allow” from the appropriate list box for each feature to which you want the user to have access.
7. Click on the Add New User button.

In an exemplary PPS system, a user can specify an e-mail address or addresses to receive one-time credit card and/or virtual check transactions and to receive recurring credit card and/or virtual check transactions or if these notifications are not desired, the No Email option can be selected.
1. From the Menu Bar, select the Configuration menu> Email Notices menu command> General Settings submenu command. The Email Notifications View opens.
2. To enable e-mail notifications—From the appropriate columns, select the “Email Me . . . ” option. To disable e-mail notifications—From the appropriate columns, select the “No Email . . . ” option.
3. In the appropriate column and box, type a valid e-mail address where you want the e-mail notification to be sent.
4. Click on the Update button.

Before the PPS system can scan checks or swipe bank cards, the customer information should be set up. An existing customer database can be imported and/or a user can add customer information to the PPS system database. The following instructions provide an example of how to import a customer file and how to add a new customer within the PPS application.
1. To import a Collect Direct customer file, from the Menu Bar, select the Reporting menu> Import/Export Utilities menu command. The Import and Export Utilities View opens.
2. In the System Import Utilities frame, click on the PPS Customer File Import command link. The PPS Customer Import View opens.
3. From this View, click on the Upload PPS Customer File command link.
4. In the File box, specify the path and filename you want to upload.
5. Click on the Upload File button. A WebForm1 window opens. For a successful upload, this window displays a numeric file name and tells you that your file upload was complete.

To add a new customer, a user may follow the following exemplary steps:
1. From the Menu Bar, select the Transaction Management menu, Customer Management menu command> Add New Customer submenu command. The Customer Management View opens.
2. In the appropriate boxes, select or specify the following information.
   Customer ID
   Customer Name, Address, Telephone Number, FAX Number, and e-Mail Address
   Billing Address
   Any additional information a user wants to add in the User Defined boxes
3. Click on the Add New Customer button. The Customer Management View opens. The customer added appears in the Customer Management List.

Each customer can have multiple payers, or payment options. For each customer, a user needs to set up the payment information (credit card, checking account, and/or savings account). A user can import an existing payer file and/or can add payer information to the PPS system. The following steps describe exemplary steps for importing a Collect Direct payer file.
1. From the Menu Bar, select the Reporting menu> Import/Export Utilities menu command. The Import and Export Utilities View opens.
2. In the System Import Utilities frame, click on the PPS Payer File Import command link. The PPS Payer Import View opens.
3. From this View, click on the Upload PPS Payer File command link.
4. In the File box, specify the path and filename you want to upload.
5. Click on the Upload File button. A WebForm1 window opens. For a successful upload, this window displays a numeric file name and indicates that the file upload was complete.

To add a new payer, a user may follow the following exemplary steps:
1. From the Menu Bar, select the Transaction Management menu> Customer Management menu command> Customer Listing submenu command. The Customer Management List View opens.
2. In the Options column on the row of the customer whose payer information is to be added, click on the Payment Options command link. The Payer Management View for the selected customer opens.
3. Click on the Add New Payer for <Customer Name> button. The Payer Management for Customer <Customer Name> View opens.
4. In the Customer Type box, select either the “Virtual Check” or the “Credit Card” option.
5. Verify the customer information.
6. For a Virtual Check—Type the bank Routing Number and the Checking Account Number in their respective boxes. Then, from the Check Account Type box, select either “Checking” or “Savings.”
   For a Credit Card—Type the credit card number in the Card Number box. Then, select the Expiration Month and Year from the appropriate boxes.
7. Click on the Add New Payment Option button. The Payer Management View for this customer opens. The payer option you just added appears on the last row of this View.
8. To add another payment option for this customer, repeat Steps 3 through 7.

When first logging in to the PPS Web application, the Welcome to the Virtual Terminal View appears in the application window. This View also is called the Desktop View 200. This View is used to quickly review activity.
The Current Batch frame shows the number of transactions and dollar amounts for current batch bankcard activity and virtual check activity.
The News and Information frame shows the date of recently added features, the feature name, and a command link to more information for each feature.
The Recurring Summary frame summarizes recurring information and provides a command link to each recurring activity listed.
The Collect Direct Summary frame summarizes customer information and provides customer management, check conversion, and credit card swipe command links.

Click on the command links in the Desktop View to quickly access associated Views or more information.
From the Current Batch frame, click on the View Current Batch command link. The Current Batch Report opens. Use this Report to examine, void, adjust, or process transactions generated on this report.
From the News and Information frame, click on the More Info command link on the row of the feature you want more information about.
From the Recurring Summary frame, click on the associated command link to access the Group Management View or the Schedule Management View. Click on the Edit/Review command links to access the Recurring Transaction List View for the appropriate activity.
From the PPS Summary frame, click on the Manage Customers command link to access the Customer Management View. Click on the PPS Check Conversion command link to open the PPS Virtual Check Service View. Click on the PPS Credit Card Swipe command link to launch the Collect Direct Bankcard Service View.

To scan a check, the green light on the MagTek MICR Image Optical Scanner/Reader should be on. If not, the scanner/reader needs to be attended to ensure that the green light is on and the scanner/reader is ready.
1. From the Desktop View, click on the PPS Check Conversion command link. OR: From the Menu Bar, select the Transaction Management menu> Transaction Processing menu command> PPS Check Conversion submenu command. The PPS Virtual Check Service View opens.
2. When the Status box prompts to “Scan front of check . . . ,” hold the check to be scanned with the front facing the PPS tag on the Scanner/Reader. Place the check over the green light and slide it into the scanner until it grasps the check and scans it through to the back side of the scanner. A user should be able to see the right half of the check at the back of the scanner, with the front of the check facing the user. The Status box displays “Acquiring file” and, then, “OK.” Next, the PPS Virtual Check Service—Review View opens.
3. Select the Originator ID, type the Grand Total, and retype the Grand Total. An optional Memo can be typed and an indication provided whether or not to send an e-mail confirmation to the Payer.
4. Click on the Submit Transaction button. The Transaction Results View opens, with a Response of “Approved.” From this View, a user may review the current batch or process another check conversion.
5. Remove the check from the scanner. The check must be destroyed within 14 days according to current NACHA regulations. As would be understood by one skilled in the art, the checks may be destroyed after another period if so required by an applicable regulation.

If the customer or payer is not in the PPS database when scanning a check, the PPS system recognizes this and presents command links to add the customer and/or payer after scanning the check.
1. From the Desktop View, click on the PPS Check Conversion command link. OR: From the Menu Bar, select the Transaction Management menu> Transaction Processing menu command> PPS Check Conversion submenu command. The PPS Virtual Check Service View opens.
2. When the Status box prompts to “Scan front of check . . . ,” hold the check with the front facing the PPS tag on the Scanner/Reader. Place the check over the green light and slide it into the scanner until it grasps the check and scans it through to the back side of the scanner.
   A user should be able to see the right half of your check at the back of the scanner, with the front of the check facing you. The Status box displays “Acquiring file” and, then, “OK.” Next, the Collect Direct Virtual Check Service—Review View opens. It displays the message: “Collect Direct was unable to locate this payer.”
3. To add a new customer and payer information—Click on the Add New Customer and Payer command link. The Customer Management View opens. Specify the required information.
   To add a new payer to an existing customer—Click on the Add Payer to Existing Customer command link. The Payer Management for Customer View opens. Specify the required information.
   To change payer information—Click on the Update Existing Payer with Check Data command link. Specify the required information.
4. When finished specifying the required information, click on the Add New Customer button or the Add New Payment Option button, as appropriate. The PPS Virtual Check Service—Review View opens. It displays the new customer and payer information.
5. Select the Originator ID, type the Grand Total, then retype the Grand Total. If desired, a Memo can be typed and an indication provided whether or not to send an e-mail confirmation to the Payer.
6. Click on the Submit Transaction button.
   The Transaction Results View opens, with a Response of “Approved.” From this View, you can review your current batch or process another check conversion.
7. Remove the check from the scanner and return it to the customer.

To swipe a credit card a user may follow the following exemplary steps:
1. From the Desktop View, click on the PPS Credit Card Swipe command link. OR: From the Menu Bar, select the Transaction Management menu> Transaction Processing menu command> PPS Card Swipe submenu command.
   The PPS Bankcard Service View opens.
2. Hold the credit card upside down with the front of the card facing the user and the magnetic stripe facing the Optical Scanner/Reader.
3. Place the card at either the far right or the far left of the top slot (the Optical Reader).
4. Swipe the card through the Optical Reader slot (either left-to-right or right-to-left).
   The PPS Bankcard Service—Review View opens. It is similar to the PPS Virtual Check Service—Review View.
5. If this is a new credit card customer or payer, a user can add the required information from the command links provided on the PPS Bankcard Service—Review View. Follow the instructions provided in Steps 2 and 3 of the previous topic: Scan a Check—New Customer.
6. Click on the Submit Transaction button.
   The Transaction Results View opens, with a Response of “Approved.” From this View, you can review your current batch or process another credit card swipe.
7. Return the credit card to the customer.

Before working with reports, a user need to configure how the reports should look. Then, the reports can be generated. The PPS system can be set up to generate reports in either the Standard Report Format or in a Short Report Format. The Standard Report Format generates a full report. The Short Report Format generates an abbreviated version of the report. The following steps describe exemplary process for setting up a transaction listing report.
1. From the Menu Bar, select the Configuration menu> User Preferences menu command. The User Preferences View opens.
2. In the Transaction Listing Options frame, select the options you want to appear in your Transaction Reports.
   To show the Report Heading—select “Yes.”
   To show the Report Summary—select “Yes.”
   To generate a report in standard format—select “Standard Format.”
   To generate a report in short format—select “Short Format.”
3. Click on the Update Preferences button.

The following steps describe an exemplary process for setting up a transaction listing report.
1. From the Menu Bar, select the Configuration menu> User Preferences menu command. The User Preferences View opens.
2. In the Settlement Listing Options frame, select the options you want to appear in your Settlement Reports.
   To show the Report Heading—select “Yes.”
   To show the Report Summary—select “Yes.”
   To generate a report in standard format—select “Standard Format.”
   To generate a report in short format—select “Short Format.”
3. Click on the Update Preferences button.

According to an exemplary embodiment of the PPS System, there are three types of reports available: Custom Reports, Searchable Reports, and System Reports.
Custom Reports (Transaction Review) let a user select or specify options to “customize” a report to the user's specific needs.
Searchable Reports (Other Reporting) let the user select a finite set of search criteria to redefine the generated report.
System Reports let the user generate them; however, the user cannot change the report criteria or results—the system generates these as a “canned” report.

When a user clicks on a Custom Report (Transaction Review) menu command or command link, the PPS system opens the Define Report Criteria View. The Define Report Criteria View lets a user select or specify a set of reporting criteria that defines what to see in the report. To generate a Custom Report, click on the Submit Transaction Search button (at the bottom of the View).

The following list provides titles of exemplary PPS custom Reports.
Archived History Transaction Report
Last 6 Months Transaction Report

When a user clicks on a Searchable Report menu command or command link, the system first displays a Search Transaction frame or a Reporting Selection frame. The Search Transaction frame lets the user select a smaller set of search criteria. Click on the Search button to refine and generate a new report.

The Reporting Selection frame limits what a user can select even more. Select an option from the drop-down list of options. Then, click on the Refresh button to redisplay the Report.

The following list provides exemplary titles of the PPS Searchable Reports.
Customer Management Report
EFT Rejects Report
Recurring Transaction Report

When a user clicks on a System Report command or command link, the system immediately generates the report—the Define Report Criteria View does not open nor does the Search Transaction frame appear. A user cannot change or tailor the results of a System Report. The user can only change the format of the report by specifying either the Standard Report Format or the Short Report Format.

The following list provides exemplary titles of the PPS System Reports.
Batch Prepared Summary Report
Credit Card Expiration Report
Current Batch Detail Report
Current Batch Summary Report
EFT Repayments Report
Past 30 Days Transaction Report
Past 7 Days Transaction Report
Settled Batch Report (Last 90 Days)
Today's Activity Transaction Report
Transaction Detail Report
Transaction Results Report

If a user print directly from the Report View, the print results may vary (the Report text may be broken up and difficult to read and the Report may be too wide for your printer's margin definitions). To ensure that the entire Report is printed and readable, click on the Printable Version command link that appears at the bottom of each Report generated.

Depending upon the type of report generated, the Options column of the Settled Batch Detail Report Listing provides command links that let a user view details about a transaction record, void the transaction, adjust the transaction, or manually credit a customer.
View Option—Generates the Transaction Detail Report. This report provides a record of the transaction that details customer, transaction, and authorization information.
Void Option—Only available for transactions that have not been settled. Opens the Transaction Results Report. The message field should read “Void Successful.”
Adjust Option—Only available for transactions that have not been settled and for certain types of credit card transactions. Lets you change incorrect information before settling the transaction
Manual Option—Use this option to issue a credit to the customer. For a Virtual Check transaction, the Manual Virtual Check Transaction View opens. For a credit card transaction, the Manual Bankcard Transaction View opens. Refer to the “Manually Credit a Customer” topic.

On the Desktop View 200, the Current Batch frame provides a quick summary of bankcard and virtual check activity. A user can generate a more detailed batch report.
1. From the Current Batch frame, click on the View Current Batch command link. OR: From the Menu Bar, select the Batch Management menu> Current Batch Summary menu command.
   The Current Batch Summary Report opens. It lists all transactions in the current batch as well as a summary of all activity.
2. From the Transaction Listing, locate the row of the transaction you want to work with. In the Options column of that row, click on the option desired.

The Settle Current Batch command closes and submits transactions for payment by the relevant financial institutions
1. From the Menu Bar, select the Batch Management menu> Settle Current Batch menu command.
   The Terms and Conditions View opens.
2. From the View, select the option button for the type of batch you want to settle.
   Settle Bankcard and Virtual Check Batches
   Settle Bankcard Batch Only
   Settle Virtual Check Batch Only
3. Click on the I Agree, Proceed with Batch Close button.
   The Batch Close Transaction Report opens.
   Note: Depending upon the type of transaction, this Report may contain AuthOnly (authorization only) check boxes in the Select for Settlement column. A user can select specific transactions you want to settle, or you can click on the Select All Transactions button, which selects all of the check boxes for settlement.
4. Click on the Continue with Batch Close button.
   The Batch Prepared Summary Report opens. Use this Report to review the Batch the user is about to settle.
5. Click on the Review Complete, Close the Batch Detail Listed Above button.
   The Batch Close Results View opens.
   If you chose the Settle Bankcard and Virtual Check Batches option—this View displays both the Bankcard and the Virtual Check Batch Close Results Views.
   If you chose the Settle Bankcard Batch Only option—just the Bankcard Batch Close Results View opens.
   If you chose the Settle Virtual Check Batch Only option—just the Virtual Check Batch Close Results View opens.
   If the View Quick Tips Bar is open at the bottom of the application—the message states: “Congratulations, your batch has been settled.”

Reject reporting is available in three ways through the exemplary embodiment of the PPS system: via facsimile, via e-mail, and through the EFT Rejects Report function in the PPS Web application.
1. From the Menu Bar, select the Reporting menu> Other Reporting menu command> EFT Rejects submenu command.
   The Rejects Define Report Criteria View opens.
2. In the Date Range fields, type the date range (in MM/DD/YY format) that the Report is to cover.
3. If it is desired to refine the EFT Reject Report results to just a single customer, type the name of the customer in the Customer Name box.
4. If it is desired to refine the EFT Reject Report results to a specific dollar amount, type the amount (in 0.00 format—no $ sign) in the Reject Amount box.
5. From the Report Format box, select either the HTML, NACHA, FEP, or Comma Delimited File option.
6. Click on the Begin Search button.
   The Reject Report Change Notification Listing opens.
   Note: In the Code column, click on a Code command link to open the Virtual Check—Correction Notices Guide. This Guide provides both Correction and Reject Codes, a description of each code, and recommended corrective actions.

The EFT Repayments Report shows pending repayments, transactions on hold, and repayments made in the last 30 days.
1. From the Menu Bar, select the Reporting menu> Other Reporting menu command, EFT Repayments submenu command.
   The EFT Repayments Report opens.
2. In the Pending Repayments frame, view the repayments that are pending, the date the repayment is scheduled to be made, and the amounts and totals of the pending repayments.
3. In the Transactions on Hold frame, view those transactions that are being held by the NET1 Risk System.
4. In the Repayments in Last 30 Days frame, view those transactions that were repaid in the last 30 days, the date the repayment was made, and the amounts and totals of the repayments.

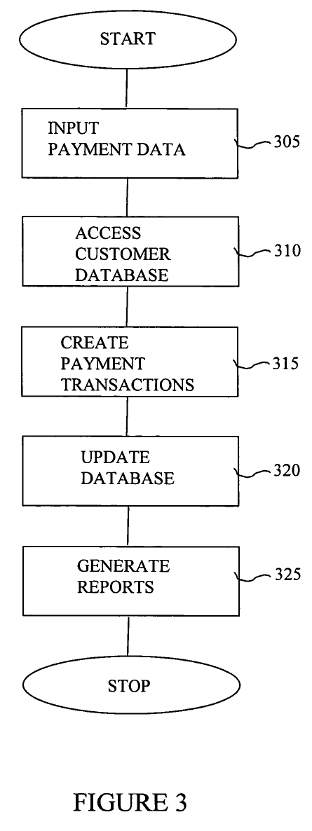

FIG. 3 is flow chart that illustrated the payment processing steps in one embodiment of the invention. In step 305, the payment data is input based on using any one of the five or more payment types. The types of payment data that may be received by the input unit of the payment processing system includes: (1) physical credit card payments; (2) physical check payments for ACH transactions; (3) virtual recurring credit card payments (to be discussed later herein); (4) virtual recurring check/ACH payments (to be discussed further herein); and (5) check card transactions or signature debit card transactions. As noted earlier, the payment processing system is designed to process at least three different types of payments to facilitate the efficient back office processing of payments.

As discussed earlier herein, this payment data may be scanned in based on a check or card presented by a user. Alternatively, for the recurring payment data, the payment data may be generated based on the data stored in the database 150. That is, a computer program could be periodically executed (for example, once a month), to generate all payment data for all monthly recurring payments.

In step 310, the customer database 150 is accessed to gather additional data that is required to create the payment transactions in step 315. In case of a check or card scanned in, the account number retrieved from the check or card data could be used as an index to access other data about the user that is required to complete the transaction. As discussed earlier herein, for example with respect to rental payments, the database 150 may contain information about how rental payments are to be allocated among multiple renters or specify alternative sources for payment for a renter.

Therefore, based on the customer specific information in the customer database 150, the payment transactions are created in step 315. In addition, to creating the transactions, step 315 also involves processing the payment transactions by sending the payment transactions for electronic clearance. For example, the payment transactions based on checks are sent to the ACH while payment transactions based on credit or other cards are sent for clearance to the payment systems associated with the credit or other cards. As discussed earlier herein, these payment transactions may be sent for clearing in real-time or in batches or some combination of the two might be used.

Thereafter, once the payments have been processed (including rejects), the database is updated in step 320 with the results of the payment processing. Each customer's account information is updated and any holds or other restrictions that need to put on any accounts are also recorded in the database 150. Thereafter, any of the various types of reports discussed earlier herein maybe generated in step 325 based on the updated data stored in the database.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated

What is claimed is:

1. An integrated payment processing system comprising:
an input unit that receives payment data from at least three different payment types;
a processing unit that processes the payment data to associate the payment data with one or more payers and one or more goods or services; and
a user interface unit that allows a user to configure the payment processing system and configure the processing unit to process the payment data received by the input unit.

2. The integrated payment processing system according to claim 1, further comprising an integrated scanner that scans both a check and a credit card to generate the payment data.

3. The integrated payment processing system according to claim 1, further comprising a customer database that stores information related to the payers and the goods and services.

4. The integrated payment processing system according to claim 3, wherein the customer database contains a payer indicia that associates payment data to a payer.

5. The integrated payment processing system according claim 4, wherein the payer indicia comprises one of a bank and account number or a credit card number.

6. The integrated payment processing system according to claim 3, wherein the customer database contains a service indicia that associates the payer to a good or service.

7. The integrated payment processing system according to claim 6, wherein the service is an apartment rental and the service indicia comprises an identification of an apartment.

8. The integrated payment processing system according to claim 7, wherein the customer database associates multiple payers with one apartment, wherein one of the multiple payers being identified as a tenant.

9. The integrated payment processing system according to claim 8, wherein the customer database associates respective specific percentages of rent for an apartment to the respective multiple payers.

10. The integrated payment processing system according to claim 1, wherein the payment processing system receives payment data from at least three payment types comprising physical credit card payments, physical check or ACH payments, virtual recurring credit card payments, virtual recurring check/ACH payments, check card transactions or signature debit card transactions

11. The integrated payment processing system according to claim 1, wherein the user interface unit allows a user to configure the processing unit to process the payment data as a one time transaction or in a batch transaction.

12. The integrated payment processing system according to claim 1, wherein the user interface unit allows a user to configure an administrative hierarchy which allows different users at different levels of the hierarchy to view or process different sets of payment data.

13. The integrated payment processing system according to claim 3, further comprising an import utility that imports payer information from an external source.

14. The integrated payment processing system according to claim 3, wherein the processing system is configured to automatically access a second payment type if a first payment type does not cover a payment, wherein the customer database comprises an indication that permits accessing multiple payment types and identification of the permissible payment types.

15. The integrated payment processing system according to claim 2, wherein the integrated scanner is not located at a point-of-sale.

16. A computer implemented method for integrated processing of payments, comprising:
receiving, at a payment processing computing system, payment data from at least three different payment types;
processing the payment data to associate the payment data with one or more payers and one or more goods or services; and
providing an interface to allow a user to configure the payment processing computing system to process the payment data received by the input unit.

17. The computer implemented method according to claim 16, further comprising providing an integrated scanner that scans both a check and a credit card to generate the payment data.

18. The computer implemented method according to claim 16, further comprising providing a customer database that stores information related to payers and goods and services.

19. The computer implemented method according to claim 18, further comprising providing a payer indicia in the customer database that associates payment data to a payer.

20. The computer implemented method according to claim 19, wherein the payer indicia comprises one of a bank and account number or a credit card number.

21. The computer implemented method according to claim 18, further comprising providing a service indicia in the customer database that associates the payer to a good or service.

22. The computer implemented method according to 21, wherein the service comprises an apartment rental and the services indicia comprises an identification of an apartment.

23. The computer implemented method according to claim 22, wherein the customer database associates multiple payers with one apartment, wherein one of multiple payers being identified as a tenant.

24. The computer implemented method according to claim 23, wherein the customer database associates respective specific percentages of rent for the one apartment to the respective multiple payers.

25. The computer implemented method according to claim 16, wherein the at least three payment types comprise three or more among physical credit card payments, physical check or ACH payments, virtual recurring credit card payments, virtual recurring/ACH payments or check card transactions or signature debit transactions.

26. The computer implemented method according to claim 18, further comprising automatically accessing a second payment type if a first payment type does not cover a payment, wherein the customer database comprises an indication that permits accessing multiple payment types and identification of the permissible payment types.

27. A computer program product comprising a computer readable medium having program code recorded thereon that, when executed, causes a computing system to perform integrated payment processing, the program code comprising:
code for receiving, at a payment processing computer, payment data from at least three different payment types;
code for processing the payment data to associate the payment data with one or more payers and one or more goods or services; and
code for allowing a user to configure the payment processing computer to process the payment data received by the input unit.

28. The computer program product according to claim 27, further comprising code for accessing a customer database that stores information related to payers and goods and services.

29. The computer program product according to claim 28, wherein the customer database includes a payer indicia that associates payment data to a payer.

30. The computer program product according to claim 28, wherein the customer database includes a service indicia that associates the payer to a good or service.
